(19) United States
(12) Patent Application Publication
(10) Pub. No.: US 2014/0067772 A1
(43) Pub. Date: Mar. 6, 2014

(54) METHODS, APPARATUSES AND COMPUTER PROGRAM PRODUCTS FOR ACHIEVING EVENTUAL CONSISTENCY BETWEEN A KEY VALUE STORE AND A TEXT INDEX

(71) Applicants: Marwan Sabbouh, Chelmsford, MA (US); Wei Liu, Acton, MA (US); Jain Richin, Cambridge, MA (US)

(72) Inventors: Marwan Sabbouh, Chelmsford, MA (US); Wei Liu, Acton, MA (US); Jain Richin, Cambridge, MA (US)

(73) Assignee: NOKIA CORPORATION, Espoo (FI)

(21) Appl. No.: 13/601,498

(22) Filed: Aug. 31, 2012

(51) Int. Cl. G06F 17/00

(52) U.S. Cl. 707/690; 707/E17.007

(57) ABSTRACT

An apparatus for reconciling data inconsistencies between indexes may include a processor and memory storing executable computer code causing the apparatus to at least perform operations including retrieving first metadata from a key value store in response to receipt of a request for data associated with a user. The computer program code may further cause the apparatus to retrieve second metadata from a text index in response to querying the text index for the second metadata. The second metadata may correspond to the first metadata of the key value store. The computer program code may further cause the apparatus to evaluate the first metadata of the key value store and the second metadata of the text index to determine whether there are any differences between the first metadata and the second metadata. Corresponding methods and computer program products are also provided.

### TECHNOLOGICAL FIELD

An example embodiment of the invention relates generally to atomic transaction in cloud systems and more particularly, relates to a method, apparatus, and computer program product for reconciling data inconsistencies between two disparate software components such as, for example, a text index and key value store.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to efficient and reliable indexing of databases. In this regard, database indexing may improve speed of data retrieval from a database and may result in increased storage space.

At present, services and applications may be designed in three-tier architecture. In this regard, the availability of a relational database may be expected and viewed as an indispensable component of infrastructure. However, relational databases are typically limited when faced with the demands of availability, scalability, and performance that some services place on them. To meet these demands, new approaches that favor NOT ONLY Structured Query Language (NoSQL) architecture over relational-database architecture may be needed. Since some of the basic Structured Query Language (SQL) operations in relational engines may be missing in NoSQL approaches such as, for example, the availability of multiple statement transactions, a service's functionality may be implemented by using the functionality of a key value store and text index. By using these features, some services may be able to count on the scalability, reliability, and high availability of the NoSQL approach.

Currently, when using a NOSQL based cloud system, consideration may be given regarding the manner in which to represent a service's data model in key/value pairs in a key value store and as an index in a text index. Even though the key value store and the text index are typically two independent components of cloud systems, the key value store and the text index generally may share the same data. Typically, both the key value store and the text index may be needed to implement functionalities of a service. In one scenario, results returned from a master storage such as a key value store may be utilized to formulate search queries against an index. In another scenario, results returned from search queries may be utilized to retrieve data from a master storage. Hence, it may be critical that the information distributed to a key value store and text index be consistent.

At present, a NoSQL based cloud system consisting of a key value store and a text index may not offer transactional support for write operations. Currently, a customer of this cloud system may require that some data either be written to both the key value store and to the text index, or that the data does not get written to either the key value store or the text index. In such cases, the customer may have the burden of making that happen. For example, a CATALOG service may save a data model in the key value store, and then the data model may get indexed in the text index. In an instance in which a network failure, or a computer failure, occurs before the data model is saved to the text index, the data in the key value store may be out of sync with the data in the text index. This may be a problem since the text index may permit the discovery of the data model by other users of the system.

Currently, engineers typically resort to using relational databases to address these problems. Relational databases offer transaction statements where a transaction is a single unit of work. In an instance in which a transaction is successful, all of the data modifications during a transaction may become permanent. Should an error occur during a transaction, then all of the data modifications may be rolled back (e.g., none of the data modifications may be made to a database(s)). Relational databases may utilize a two phase commit protocol to ensure atomic commitment of data among the databases. In this regard, a transaction as provided by a relational database management system may have the following form:

Begin Transaction:

Make an update of data in database 1 (DB1).

The system may then make an update of the data in database 2 (DB2).

Commit Transaction:

Unlike relational databases, the two phase commit protocol is typically not available for usage in resolving conflicts among a key value store and a text index.

In view of the foregoing drawbacks, it may be beneficial to provide an efficient and reliable mechanism of reconciling data inconsistencies among key value stores and text indexes.

### BRIEF SUMMARY

A method, apparatus and computer program product are therefore provided for reconciling data conflicts between two software components. In this regard, an example embodiment may reconcile data conflicts in a master storage (also referred to herein as key value store) and a text index. The data conflict may occur, for example, in an instance in which a user submits a data model such as, for example, a document or any suitable data (e.g., a metadata record) to be stored in master storage and then to be indexed by the text index, but a partial failure occurred before an indexing process which caused the data in the text index to be inconsistent with the data in master storage.

To reconcile data in the key value store and the text index, an example embodiment may generate a set of metadata that is associated with the data model as the value of a key that uniquely identifies the user, for each publish data model request by a user. Further, the document associated with the data model and the set of metadata may be stored in the key value store as values of two different keys. The first key being a unique identifier in the key value store, the second key being the first key augmented by a version number. Therefore, a request to upgrade the data model may not result in overwriting the existing data model in the key value store, but instead writes the updated data model as the value of a key augmented by an updated version number, in addition to writing the updated data model as the value of the key. The metadata may include, but is not limited to, a unique key of the document being stored in key value store, a version number, a creation date, and the author of the document.

In addition, an example embodiment may, for each indexing request by a user, populate the text index with the corresponding metadata (e.g., the same metadata or substantially the same metadata stored in the master storage) associated with the document in addition to the document.

The key value store may be designated as the authoritative data source relative to the text index. In this regard, the key value store may have priority for resolving data conflicts between the key value store and the text index. This may allow a communication device of an example embodiment to search for and identify keys, on a per user basis, whose values or metadata may be in the master storage, but that are not in the text index. Subsequently, the communication device may perform an indexing process to update or write the values or metadata, stored in the master storage, to the text index. In this manner, a communication device of an example embodiment may reconcile data conflicts between the master storage and the text index.

In one example embodiment, a method for reconciling data inconsistencies between a key value store and a text index is provided. The method may include retrieving first metadata from a key value store in response to receipt of a request for data associated with a user. The method may further include retrieving second metadata, corresponding to the first metadata of the key value store, from a text index in response to querying the text index for the second metadata. The method may further include evaluating the first metadata of the key value store and the second metadata of the text index to determine whether there are any differences between the first metadata and the second metadata.

In another example embodiment, an apparatus for reconciling data inconsistencies between a key value store and a text index is provided. The apparatus may include a processor and a memory including computer program code. The memory and computer program code are configured to, with the processor, cause the apparatus to at least perform operations including retrieving first metadata from a key value store in response to receipt of a request for data associated with a user. The memory and computer program code are further configured to, with the processor, cause the apparatus to retrieve second metadata, corresponding to the first metadata of the key value store, from a text index in response to querying the text index for the second metadata. The memory and computer program code are further configured to, with the processor, cause the apparatus to evaluate the first metadata of the key value store and the second metadata of the text index to determine whether there are any differences between the first metadata and the second metadata.

In another example embodiment, a computer program product for reconciling data inconsistencies between a key value store and a text index is provided. The computer program product includes at least one computer-readable storage medium having computer-readable program code portions stored therein. The computer-executable program code instructions may include program code instructions configured to retrieve first metadata from a key value store in response to receipt of a request for data associated with a user. The program code instructions may also retrieve second metadata, corresponding to the first metadata of the key value store, from a text index in response to querying the text index for the second metadata. The program code instructions may also evaluate the first metadata of the key value store and the second metadata of the text index to determine whether there are any differences between the first metadata and the second metadata.

An example embodiment of the invention may provide a better mechanism for resolving data conflicts between a key value store and a text index in a reliable and highly scalable manner. As such, device users may enjoy improved capabilities with respect to indexing of data and for retrieving the data from indexes.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system that may include an example embodiment of the invention;

FIG. 2 is a schematic block diagram of an apparatus according to an example embodiment of the invention;

FIG. 3 is a diagram of text index fields of a text index according to an example embodiment of the invention;

FIG. 4 is a diagram illustrating a publishing access plan according to an example embodiment of the invention;

FIGS. 5A, 5B, 5C & 5D illustrate diagrams of partial failures for a publish operation according to an example embodiment of the invention;

FIG. 6 illustrates a diagram of reconciling data inconsistencies between a master storage and a text index according to an example embodiment of the invention;

FIG. 7 is a diagram of a publishing access plan according to another example embodiment of the invention;

FIG. 8A is a diagram of a partial failure for a publish operation according to another example embodiment of the invention;

FIG. 8B is a diagram illustrating reconciliation of data inconsistencies according to an example embodiment of the invention; and

FIG. 9 illustrates a flowchart for reconciling data inconsistencies between a master storage and a text index according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

Additionally, as referred to herein, the term “key value store” may be referred to interchangeably as “master storage”. In addition, as referred to herein an “asset entry” may denote a document (e.g., a metadata record) containing data or metadata (e.g., a data model, (e.g., a document)).

As referred to herein, a text index or an inverted index (also referred to herein as postings file or inverted file) may relate to an index data structure that stores a mapping from content such as, for example, words or numbers, to its locations in a database file, or in a document or a set of documents. A purpose of an inverted index may be to allow fast full text searches, at a cost of increased processing when a document is added to the database. The inverted file may be the database file itself, rather than its index. In this regard, for example, the inverted file may be a high-performance, full-featured text search engine library. Additionally, as referred to herein a key value store(s) may allow an application(s) to store/retrieve/delete/update its data as the value of a key, where the key is a unique identifier in the system. The data that is manipulated may be schema-less (e.g., does not conform to any schema).

In an example embodiment, in an instance in which a user submits a data model (or any metadata record) to be stored in a master storage (e.g., key value store) and then to be indexed by a text index, the data in the text index may be inconsistent with the data in master storage in an instance in which a partial failure occurs right before the indexing process. To reconcile data in the master storage and text index according to an example embodiment consider the following.

For every publish data model request by a user, a communication device may write the data model as the value of its unique key and may also write the data model as the value of a key in a master storage consisting of the data model unique key and version number. As such, a request to publish a data model may result in a minimum of two writes to a master storage. In this manner, the master storage may keep track of all the versions of the data model.

For purposes of illustration and not of limitation, consider an instance in which there is a key named A with some value to be written to a data model in the key value store. The value may be any suitable designated data (e.g., a numerical value, text data, a combination of one or more numerical values and text data, etc.). As such, the key value store may facilitate writing of the unique key A with some value to the key value store in one write operation. In addition, the key value store may facilitate another write operation for a unique key with some value and a version number such as, for example, A.1 in which A denotes the unique key and 0.1 denotes version one. In this manner, the key value store may store a backup for the first write operation. As such, in an example embodiment, writing of a unique key with some value to the key value store may be implemented as two write operations. The second write operation may be a backup to the first write operation and may be associated with a version number for the unique key and its value.

In addition, for every publish data model request by a user, a set of metadata may be associated with the data model, such as for example a document(s), as the value of a key (e.g., key A) that uniquely identifies the user. The document(s) itself may be stored in the key value store. The metadata may include, but is not limited to, the key of the document(s) being stored in the key value store, a version number, a creation date, the author of the document and any other suitable data.

In an example embodiment, for every indexing request by a user, a text index may be populated with the same metadata associated with the document(s) in addition to the document(s) and the key value store (e.g., the master storage) may be designated as the authoritative data source for resolving conflicts with the text index.

This approach may enable a communication device to identify one or more keys, on a per user basis, whose values may be in the key value store (e.g., master storage), but which may not be in the text index. In an instance in which one or more keys are in the key value store but are not in the text index, the communication device may retry the indexing process. The communication device may trigger this matching activity, in an instance in which a user logs in to a network or system, or at periodic time intervals. The reconciliation of data between the key value store and the text index may be performed by the communication device in the following manner.

Initially (e.g., in a first operation), the metadata associated with a document(s) may be retrieved, by a communication device, from the key value store for a specific user. Thereafter, (e.g., in a second operation) the communication device may issue a query to the text index and may retrieve the metadata (e.g., the same metadata, or substantially the same metadata, as in the first operation). Subsequently, the communication device (e.g., in a third operation) may check the differences between the metadata retrieved from the key value store and text index. Next, (e.g., in a fourth operation) the communication device may trigger the indexing process for each unique key(s) (e.g., one or more Universally Unique Identifiers) (UUIDs) and version number combinations in the key value store but which may not be in the text index.

As described above, a communication device of an example embodiment may trigger this matching activity, for example in an instance in which a user logs in to a network or system that facilitates indexing management, or at periodic intervals of time, as described more fully below.

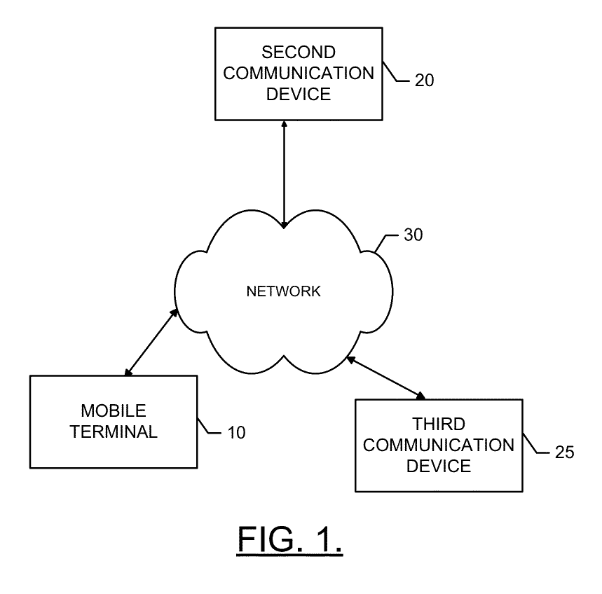

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the present invention may further include one or more additional communication devices, one of which is depicted in FIG. 1 as a third communication device 25. In one embodiment, not all systems that employ an embodiment of the present invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ an embodiment of the present invention. Furthermore, devices that are not mobile, such as servers and personal computers may also readily employ an embodiment of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE) or Evolved Universal Terrestrial Radio Access Network (E-UTRAN), Self Optimizing/Organizing Network (SON) intra-LTE, inter-Radio Access Technology (RAT) Network and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from one or more base sites. The base sites could be, for example one or more base stations (BS) that is a part of one or more cellular or mobile networks or one or more access points (APs) that may be coupled to a data network, such as a Local Area Network (LAN), Wireless Local Area Network (WLAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other. For example, the mobile terminal 10 and the second and third communication devices 20 and 25 as well as other devices may communicate according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, Radio Frequency (RF), Near Field Communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (Wi-Fi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

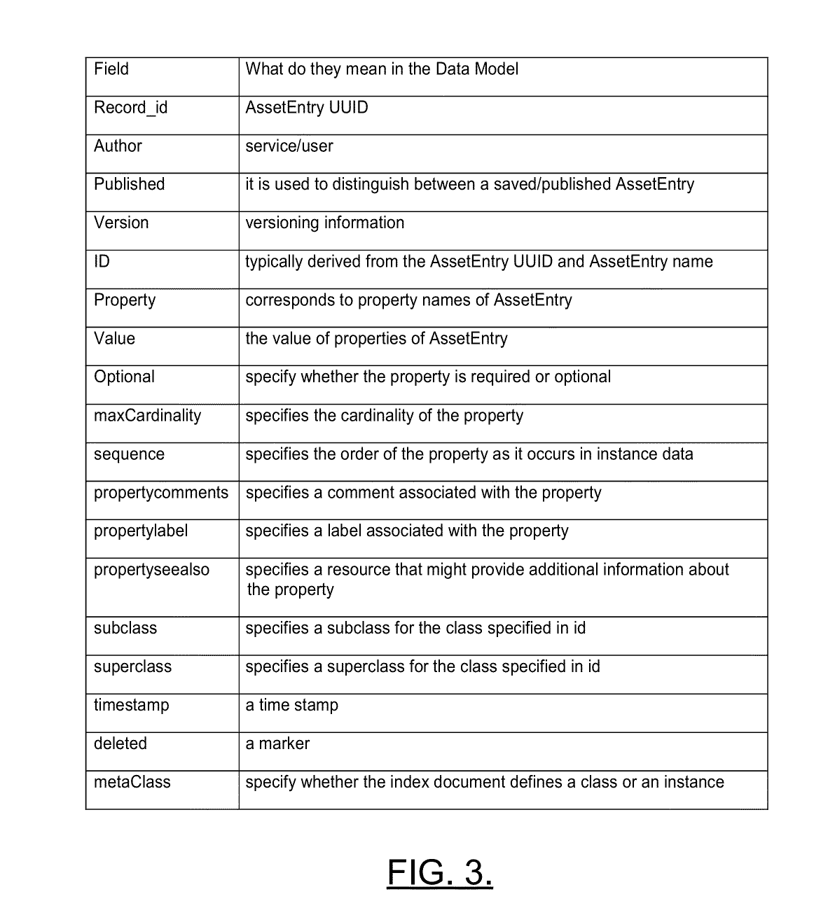

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 (e.g., network device 90 of FIG. 3) may be servers, remote computers or terminals such as personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

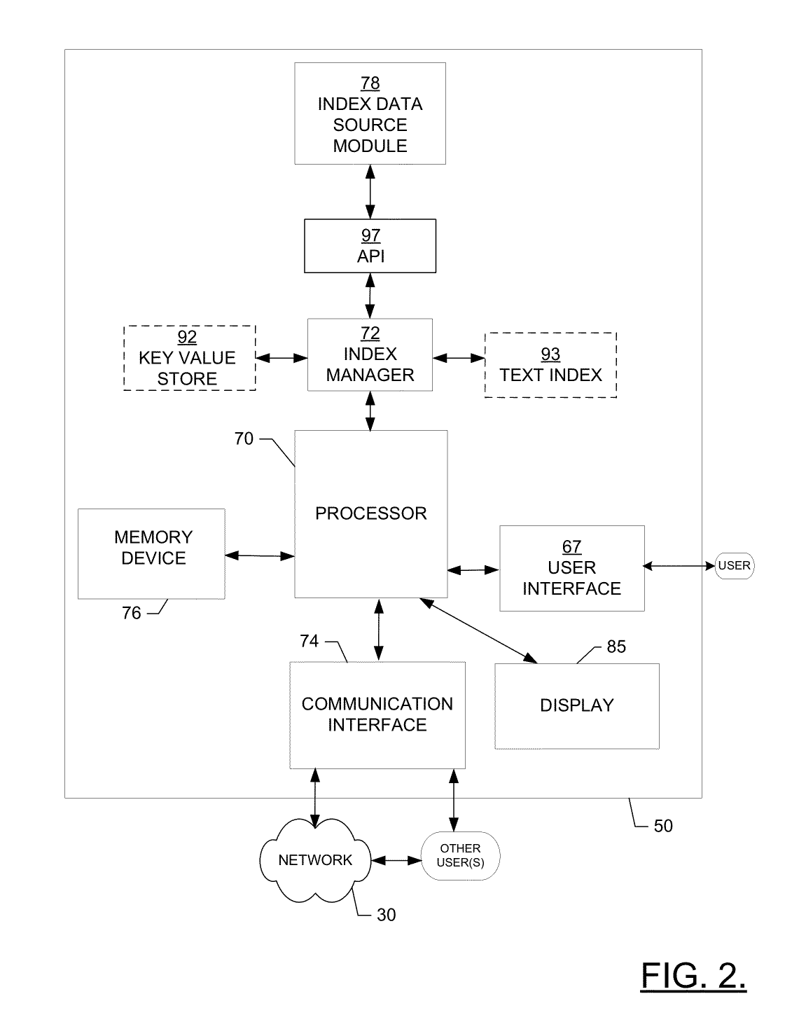

In an example embodiment, the mobile terminal as well as the second and third communication devices 20 and 25 may employ an apparatus (e.g., apparatus of FIG. 2) capable of employing an embodiment of the invention.

FIG. 2 illustrates a schematic block diagram of an apparatus according to an example embodiment. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, a communication interface 74, a memory device 76, a display 85, an index manager 72, an index data source module 78, an application programming interface (API) 97, a key value store 92 (also referred to herein as master storage 92) and a text index 93. In an alternative example embodiment, the key value store 92 and/or the text index 93 may optionally be located externally or remotely from the apparatus 50. In one example embodiment, the display 85 may be a touch screen display. The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., pictures, videos, etc.). In one example embodiment, the key value store 92 and/or the text index 93 may optionally be stored in memory device 76.

The apparatus 50 may, in one embodiment, be a mobile terminal (e.g., mobile terminal 10) or a fixed communication device or computing device configured to employ an example embodiment of the invention. However, in one embodiment, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the invention on a single chip or as a single “system on a chip.” As such, in some cases, a chip or chipset may constitute means for performing one or more operations for providing the functionalities described herein. Additionally or alternatively, the chip or chipset may constitute means for enabling user interface navigation with respect to the functionalities and/or services described herein.

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

In an example embodiment, the processor 70 may be configured to operate a connectivity program, such as a browser, Web browser or the like. In this regard, the connectivity program may enable the apparatus 50 to transmit and receive Web content, such as for example location-based content or any other suitable content, according to a Wireless Application Protocol (WAP), for example.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control the index data source module. The index data source module 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the index data source module 78, as described herein. Thus, in an example in which software is employed, a device or circuitry (e.g., the processor 70 in one example) executing the software forms the structure associated with such means.

The index data source module 78 may generate one or more requests for data to be indexed (e.g., in a database(s), memory or the like). Additionally, the index data source module 78 may generate one or more requests to publish, search, or discover one or more data models (e.g., documents, metadata records, etc.) and/or asset entries. The index data source module 78 may generate the request(s) in response to receipt of data input by a user specifying the request(s). The index data source module 78 may send one or more requests to publish, search, or discover data (e.g., data models (e.g., metadata records)) and/or asset entries to an interface such as application program interface (API) 97.

In an example embodiment, the processor 70 may be embodied as, include or otherwise control the API 97. The API 97 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the API 97, as described below. Thus, in an example in which software is employed, a device or circuitry (e.g., the processor 70 in one example) executing the software forms the structure associated with such means.

The API 97 may send one or more requests received from the index data source module 78 to the index manager 72. For purposes of illustration and not of limitation, the data of one or more of the requests may, but need not, relate to information designating to include requested data (e.g., data to be written) in the key value store 92 and/or the text index 92, to remove requested data from the key value store 92 and/or text index 93, to search or discover data in the key value store 92 and/or text index 93 or any other suitable designations.

In response to receipt of the data in one or more requests from the API 97, the index manager 72 may manage the data in the key value store 92 and/or the text index 93, as described more fully below. Additionally, the index manager 72 may resolve data conflicts between the key value store 92 and the text index 93, as described more fully below.

In an example embodiment, the processor 70 may be embodied as, include or otherwise control the index manager 72. The index manager 72 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the index manager 72, as described herein. Thus, in an example in which software is employed, a device or circuitry (e.g., the processor 70 in one example) executing the software forms the structure associated with such means.

The key value store 92 may be a storage unit or a memory device such as, for example, a volatile and/or non-volatile memory. The key value store 92 may store one or more items of requested data to be indexed and one or more key values, or the like. In addition, the key value store 92 may store the indexed data (e.g., unique key, values, etc.) and any other suitable data such as, for example, metadata. The metadata may include content indicating version information (e.g., a version number), timestamp information (e.g., a creation date, a creation time), and an author (e.g., a user) or originator of data (e.g., data written or published in the key value store 92). The metadata may also be associated with or include a unique key (e.g., a UUID) and a value(s), as described more fully below.

The text index 93 may be a storage unit or a memory device such as, for example, a volatile and/or non-volatile memory. The text index 93 may store one or more items of requested data to be indexed or the like. The indexed data of the text index 93 may be stored in a table(s). The text index 93 may store the indexed data and any other suitable data such as, for example, metadata. The metadata are related to corresponding metadata stored in the key value store 92.

In an example embodiment, the index manager 72 may be used to designate the data design associated with the key value store 92 and the text index 93. In this regard, the index manager 72 may design data for the key value store 92 specifying the keys and the values in the key value store 92, and may design a service definition file specifying the fields in the text index 93. In an example embodiment, the index manager 72 may utilize at least two data designs to specify the format of the keys in the key value store 92 and the fields definition in the text index 93. With respect to the first design, the index manager 72 may generate keys by a combination of an asset entry identifier (e.g., an UUID) and a corresponding version number. Regarding the second design, the index manager 72 may generate keys based on an asset entry identifier(s) in which at least a subset of the asset entry identifiers may not be associated with version information (e.g., a version number), as described more fully below.

In one example embodiment, the index manager 72 may generate the data design for master storage 92 in the following manner. The index manager 72 may identify each asset entry by a unique key such as, for example, a UUID in the master storage 92. Additionally, the index manager 72 may designate that each unique key be comprised of a UUID and a corresponding version number. The index manager 72 may designate the value of a key as the content of the asset entry. In an example embodiment, the unique key (e.g., UUID) with the corresponding version number may serve as a backup key to the unique key designated by the UUID (e.g., which may not be associated with a version number). For purposes of illustration and not of limitation, consider an example in which the unique key is designated for the master storage 92 by the index manager 72 as “A”. In this regard, the index manager 72 may designate the backup unique key for the master storage 92 as “A.1” where “0.1” may indicate version one. The backup key (e.g., “A.1”) also contains the metadata.

Additionally, the index manager 72 may identify each user or service by a unique key in the master storage 92 by a designation such as, for example, {service}:‘version’ Key. For instance, a user or service named “analytics” may have a corresponding analytics:version stored in the master storage 92 of the apparatus 50. The value of the key may include, but is not limited to, a listing of the asset entries associated with the user or service and some metadata (e.g., versioning information, timestamp information (e.g., creation date and time), the author of corresponding data, etc.).

The index manager 72 may also maintain and store a special key in the master storage 92, designated, for example, as a CATALOGKey, with a value(s) that may include a listing of all the users or services that published (e.g., wrote) data (e.g., data models) to the master storage 92.

The index manager 72 may generate the data design for text index 93 in the following manner. The index manager 72 may designate a service definition file that defines the text index 93 to include one or more fields (also referred to herein as field definitions). The index manager 72 may define a text index 93 to include a composite unique key (e.g., a primary key (e.g., a UUID)) that includes, but is not limited to, a Record_Id, identifier (ID), Version, Property, metaclass, metadata and any other suitable information as illustrated for purposes of example and not of limitation in the example table of text index fields associated with service definitions files as shown in FIG. 3. The table illustrates a summary of some of the fields that may be in a text index (e.g., text index 93). In an example embodiment, the text index 93 may include the metadata (e.g., version, author, and timestamp (e.g., creation date and time)) that is also associated with the corresponding unique key in the key value store 92. The text index 93 may also include one or more fields that may be populated by the index manager 72 from the content of data (e.g., a data model (e.g., a document)).

In an example embodiment, the index manager 72 may analyze data access patterns such that one or more services or users may publish or retrieve their asset entries one at a time. In this regard, each operation to access or publish (also referred to herein as write) data to the master storage 92 and/or text index 93 may be the result of a corresponding access plan to the master storage 92 and/or to the text index 93.

As described above, in one example embodiment, the index manager 72 may identify each asset entry in the master storage 92 by its unique key (e.g., a UUID). Additionally, since the index manager 72 may generate a backup key associated with the unique key (e.g., the UUID) and the version number in the master storage 92, the index manager 72 may also identify an asset entry by its UUID and version number in order to keep track of older/previous versions. The value of the key may be the content of the asset entry in addition to metadata information (e.g., a UUID(s), versioning information, timestamp information (e.g., creation date, creation time), service name, user name, etc.).

Additionally, as described above, the index manager 72 may identify each service or user by a unique key in the master storage 92. The unique key may include information indicating the corresponding service name and/or the user name. The value of the unique key may include a listing of the all of the unique keys (e.g., UUIDs) of the asset entries associated with the service or user and some metadata (e.g., versioning information, timestamp information (e.g., creation date, creation time), service name, user name, etc.).

In an example embodiment, the index manager 72 may perform one or more publish operations, for writing data, to the master storage 92 in the following manner.

In a first operation, the index manager 72 may perform a Get UUID operation to retrieve version information (e.g., version information denoted “m”), and payload information (e.g., denoted payload P) associated with a UUID written to the master storage 72. The payload P may be a value(s). In one example embodiment, the payload P may be any value(s) that a user or service has written.

In a second operation, the index manager 72 may perform a Get UUID:m operation to ensure the success of the previous publish in operation 1. In this regard, the index manager 72 may attempt to retrieve a backup key for the UUID. The backup key may be associated with the version information m.

Optionally, in a third operation, in an instance in which the Get UUID:m operation returns an indication of key not found to the index manager 72, the index manager 72 may perform a Put (UUID:m, P) to rewrite the backup key. In a fourth operation, the index manager 72 may set the version number as n=m+1. In this regard, the index manager 72 may increment the version number by 1.

In a fifth operation, the index manager 72 may perform a Put operation to update the metadata, (e.g., a UUID(s), version information, timestamp information (e.g., creation date, creation time), service name, user name, author or originator of a document(s), etc.) in an associated service key or user key, such as, for example, Put (service-key, n). In this regard, the index manager 72 may write the metadata to a user key or service key in the master storage 92.

In a sixth operation, the index manager 72 may update the payload (e.g., payload P) of a publish operation (e.g., a write operation) to include the metadata information (e.g., version information n, timestamp information (e.g., creation date, creation time), service name, user name, author or originator of a document(s), etc.). The index manager 72 may designate the updated payload as Q.

In a seventh operation, the index manager 72 may perform a Put operation to store (e.g., in the master storage 92) the updated payload Q in the corresponding key UUID. The updated payload Q may be a value of the key UUID. This Put operation may be designated by the index manager 72 such as, for example, Put (UUID, Q). In an eighth operation, the index manager 72 may perform a Put operation to store the updated payload Q in key UUID:n, in which “n” designates the updated version number. The index manager 72 may designate the Put operation to store Q in key UUID: such as, for example, Put (UUID:n, Q).

In a ninth operation, the index manager 72 may perform an invocation of the indexing process to index the asset entry. In this regard, the index manager 72 may write the data associated with the key UUID, stored in the master storage 92, in the text index 93. The service key or user key associated with the UUID, stored in the master storage 92, may also be written to the text index 93 by the index manager 72. As such, the both master storage 92 and the text index 93 may include the same, or substantially the same, data associated with the key UUID.

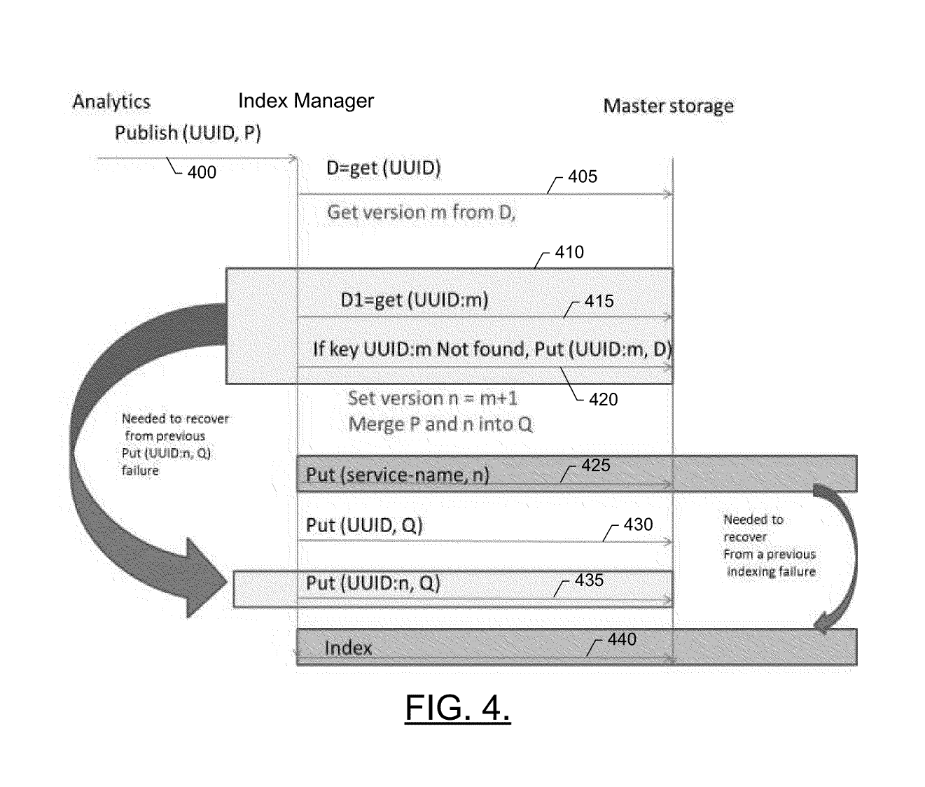

Referring now to FIG. 4, an example method of publishing data from a master storage is provided according to an example embodiment. At operation 400, the index manager 72 may receive a request for a published (e.g., written) UUID payload P. The request may be generated by the index data source module 78 in response to receipt of an indication by a user or service (e.g., a user or service named “Analytics”). At operation 405, the index manager 72 may perform a Get UUID operation to retrieve the published (e.g., written) UUID from the master storage 93. At operation 410, the index manager 72 may perform a Get UUID:m operation, where “m” denotes the version information, to retrieve the UUID:m from the master storage 93 to ensure the success of the previous publish of the UUID.

At operation 415, in response to receiving an indication from the master storage 93 that the key UUID:m is not found, the index manager 72 may perform a Put (UUID:m, D) operation to rewrite the key UUID:m to the master storage 93, where denote “D” denotes a previous value of the UUID. At operation 420, the index manager 72 may set the version number to n=m+1 and may merge payload P and version number n into updated payload Q. At operation 425, the index manager 72 may perform a Put operation to update the metadata (e.g., version information n, timestamp information (e.g., creation date, creation time), service name, user name, author or originator of a document(s), etc.) in a service key or a user key: Put (service-key, n).

At operation 430, the index manager 72 may communicate with the master storage 92 and may perform a Put operation (e.g., Put (UUID, Q)) to store updated payload Q in key UUID. At operation 435, the index manager 72 may communicate with the master storage 92 and may perform a Put operation (e.g., Put (UUID:n, Q)) to store updated payload Q in key UUID:n. At operation 440, the index manager 72 may write the asset entry associated with the key UUID, updated version number n and payload Q (e.g., UUID:n Q)), stored in the master storage 92, to the text index 93 during an indexing operation.

Optionally, at operation 415, in an alternative example embodiment, in an instance in which the index manager 72 determines that the Put (UUID:n, Q) of a previous operation fails (e.g., operation 435), the index manager 72 may utilize the version information m (e.g., a prior version) associated with key UUID corresponding to payload D (e.g., (UUID:m, D)) to recover (UUID:n, Q) to resolve the failure. In an instance in which the operation fails, the key UUID:n with payload data Q may not be properly stored in the master storage 92. Optionally, at operation 440, in an alternative example embodiment, in an instance in which the indexing of an asset entry and associated data from the master storage 92 to the text index 93 fails, the index manager 72 may utilize the data (e.g., metadata) of a user key or service key (e.g., service-key, n) to recover from the indexing failure. For example, the index manager 72 may utilize the metadata associated with the user key or service key to ensure data consistency between the master storage 92 and the text index 93. By analyzing the metadata associated with the user key or the service key the index manager 72 may retrieve data (e.g., current version information), from the user/service key, associated with the asset entry (e.g., a UUID) and may provide or write the data (e.g., UUID:n, Q) associated with the retrieved data (e.g., the current version information) to the text index 93 to reconcile any data inconsistences between the master storage 92 and the text index 93.

In the example embodiment of FIG. 4, a published asset entry may be stored as the value of two different keys in the master storage 92. The first unique key may be its UUID, and the second unique key may be its UUID with the latest version information (e.g., {UUID:latest-version}). Storing the asset entry as the value of its UUID may enable its retrieval by knowing the UUID. As described above, the index manager 72 may augment the asset entry with metadata information. The same metadata information may also be stored in the master storage 92 in part as the value of key (e.g., {service-name}). In an example embodiment, the metadata information in the service key or user key may be utilized by the index manager 72 to ensure data consistency between master storage 92 and text index 93, as described above.

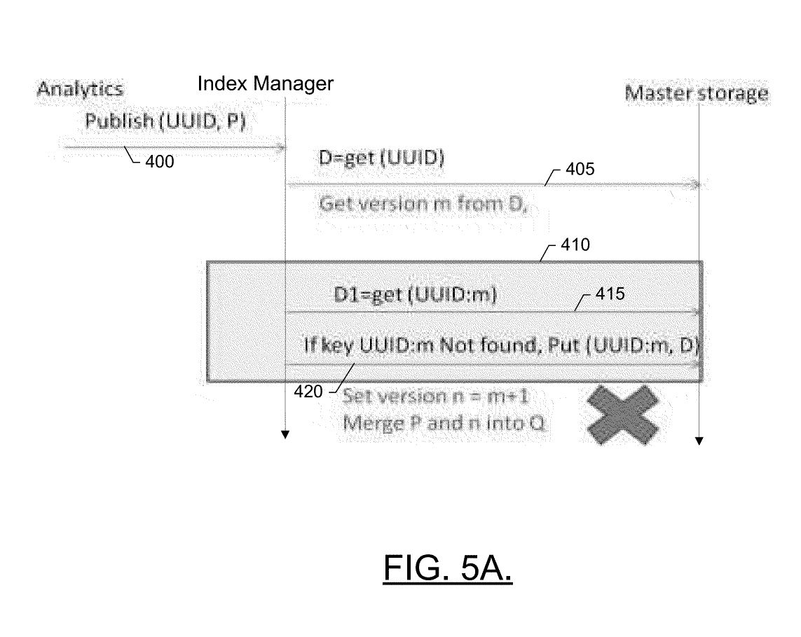

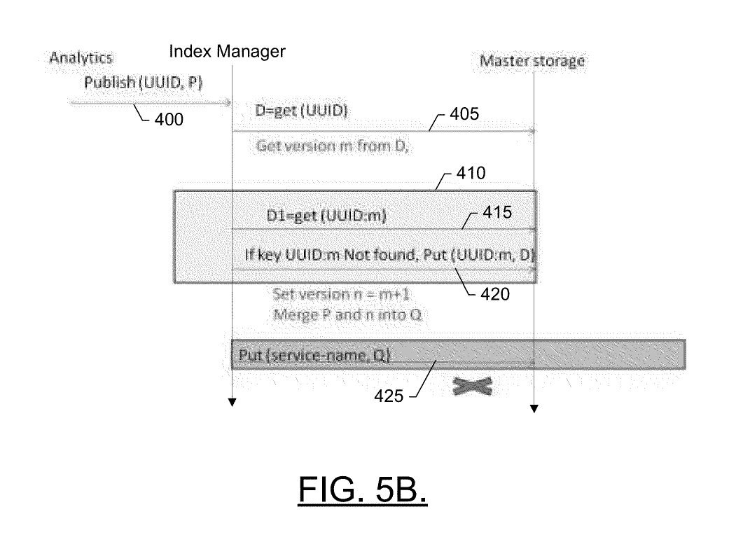

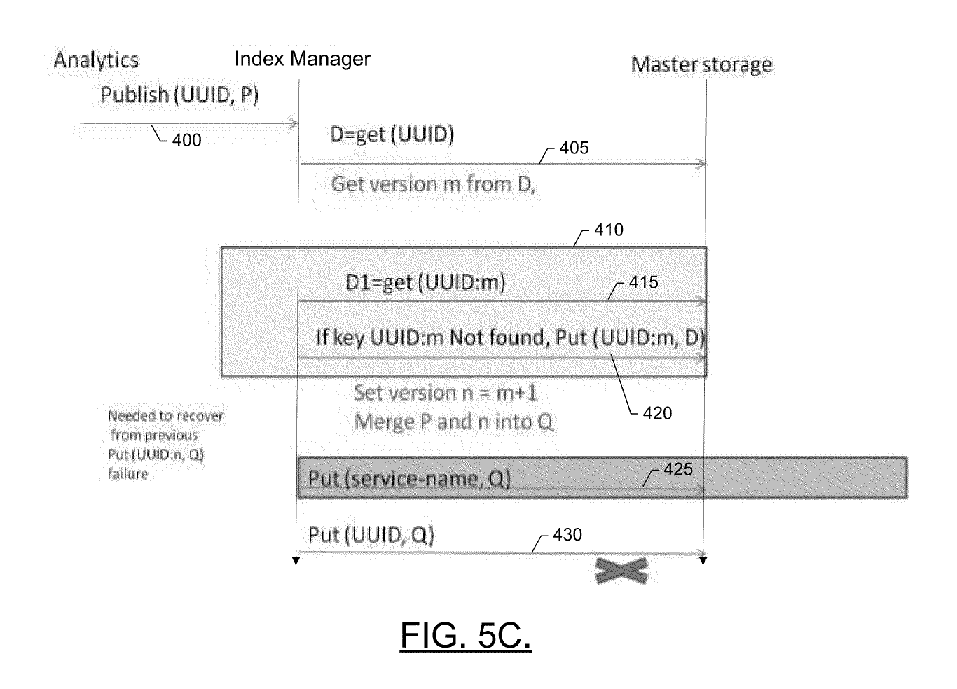

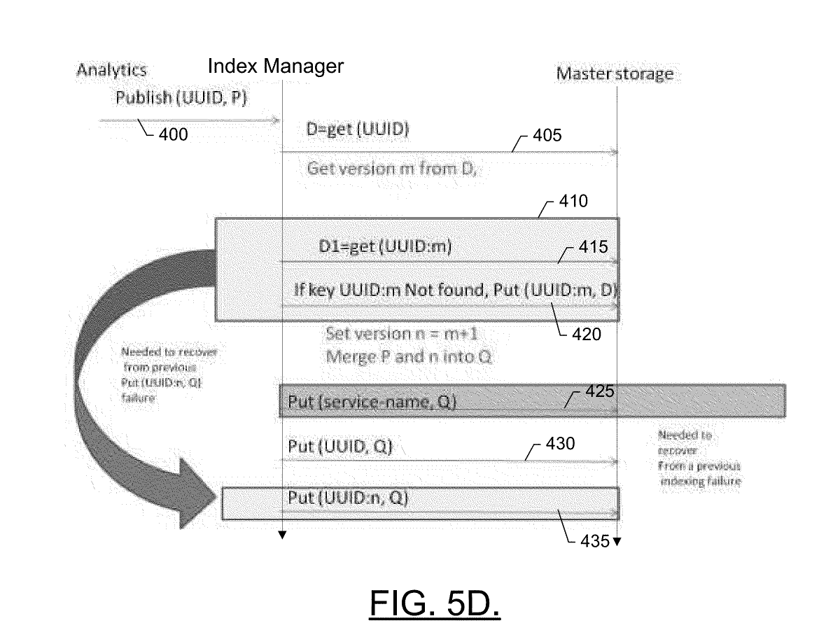

Referring now to FIGS. 5A-5D, diagrams illustrating reconciling data inconsistences due to a failure are provided according to an example embodiment. In other words, FIGS. 5A-5D illustrate scenarios for resolving data inconsistencies that may arise due to one or more partial failures in a system of an example embodiment.

FIG. 5A shows a failure as a result of the publish UUID by user analytics. In particular, FIG. 5A shows a failure after operation 415 in which the version number was updated by n=m+1. Since the index manager 72 does not store any new information before the failure occurs, the index manager 72 may provide a timeout error to a display (e.g., display 85) that may be viewed by a user.

FIG. 5B shows a failure as after the service/user key is updated with the new metadata in operation 420. The example in FIG. 5B shows that while the version was incremented successfully as the value of the {service-name} key, the actual asset entry was not stored successfully in the master storage 92. In this regard, the index manager 72 may provide an indication of a timeout error to a display (e.g., display 85) to enable the user (e.g., a user named “Analytics”) view the timeout error. This failure may be self-correcting on the next publish operation by the index manager 72. For example, on another publish operation, the index manager 72 retrieves the version number in operation 405, increments the version number, and rewrites the version number in operation 425, then proceeds to execute operations 430 to 440 in sequence (e.g., operations 430-440 shown in FIG. 4). Since the {service-name} key may be used by the index manager 72 to ensure data consistency between master storage 92 and the text index, that index manager may account for a version of a unique key that may be marked or identified in the {service-name} without having a corresponding unique key {UUID:version} in the master storage 92.

FIG. 5C shows another scenario for a partial failure in which the failure occurs after publishing (e.g., writing) the asset entry as the value of the key UUID. In other words, the failure occurs after operation 425. In response to this detected failure, the index manager 72 may include the asset entry as the value of the key UUID but not necessarily as value of the key {UUID: latest-version}. As such, on a next publish operation, the index manager 72 may copy the value of key UUID and may store the copied value in key {UUID: version} in the master storage 92 upon execution of operation 420.

FIG. 5D shows a partial failure before the operation 435. In other words, in the example embodiment of FIG. 5D, the index manager 72 may detect a failure right after operation 430 in an instance in which the index manager 72 attempted to perform a Put operation to store an updated payload Q in a key UUID with a version number n (e.g., Put UUID:n, Q). On the next publish operation, the index manager 72 may execute the operations in sequence. At operation 420 a Key Not Found is returned and the index manager 72 may write a previous payload in key UUID with version n.

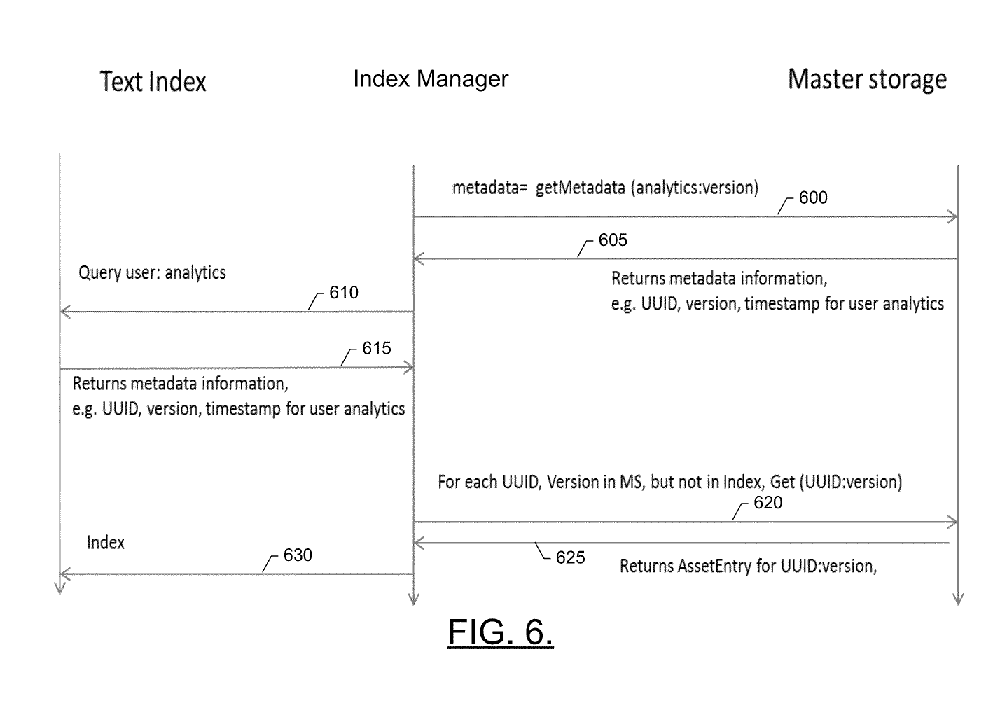

Referring now to FIG. 6, a diagram illustrating an example method of reconciling data inconsistencies between a master storage and a text index is provided according to an example embodiment. In the example embodiment of FIG. 6, there may be data inconsistencies between the master storage 92 and the text index 93 based in part on a partial failure right before or during an indexing operation.

In an instance in which a partial failure occurs right before the indexing process, or during the indexing process, the data in the text index 93 may be inconsistent with the data in master storage 92. The index manager 72 may reconcile data in the master storage 92 and the text index 93 based in part on the following considerations.

The master storage 92 may include the metadata associated as the value of a key service-name or key user-name, in addition to one or more corresponding asset entries (e.g., other key UUIDs). The text index 93 may also include at least some of the metadata associated with the corresponding asset entries in addition to the asset entries. However, the master storage 92 may be designated as the authoritative data source for resolving data conflicts between the master storage 92 and the text index 93.

In this manner, the index manager 72 may search for keys whose values are in the master storage 92, but which may not be in the text index 93 (e.g., missing from the text index 93) and subsequently the index manager 72 may retry the indexing process (e.g., operation 440 of FIG. 4) since a previous indexing process may have failed. The index manager 72 may trigger this matching activity, in response to receipt of an indication that a user logged in to a network or system for indexing the data of the master storage 92 and/or the text index 93, or at periodic time intervals.

As described above, the master storage 92 may store the metadata associated with the value of a key service-name and/or a key user-name, and the index manager 72 may write new or updated metadata to the service key and/or user key. (See e.g., operation 425 of FIG. 4) The metadata of the text index 93 should be the same, or substantially the same, as the metadata of the master storage 92 to avoid any data conflicts between the master storage 92 and the text index 93.

In an instance in which there is a data conflict between the master storage 92 and the text index 93, the index manager 72 may use the metadata associated with a service key or user key of the master storage 93 to recover the metadata missing from the text index 93 and may rewrite the metadata (e.g., the missing metadata) to the text index 93, as described more fully below. To detect whether there is a data discrepancy between the master storage 92 and the text index 93, the index manager 72 may analyze the metadata in the text index 93 and the metadata that is available in the service key or user key of the master storage 92. In an instance in which, the index manager 72 determines that the service key or user key stored in the master storage 92 has metadata that is not in the text index 93, the index manager 72 may rewrite the metadata (e.g., version information (e.g., a version number), timestamp information (e.g., a creation date, a creation time), an author or originator of a document(s), etc.) associated with the service key or user key again to the text index 93.

Referring again to FIG. 6, a reconciliation process for a user named analytics is provided according to an example embodiment. At operation 600, the metadata associated with an asset entry may be retrieved by an index manager (e.g., index manager 72) from master storage (e.g., master storage 92) for the user analytics using the key service-name, e.g., analytics. At operation 605, the index manager (e.g., index manager 72) may retrieve the requested metadata information for user analytics from the master storage (e.g., master storage 92). This metadata may include but is not limited to a corresponding UUID, a timestamp for user analytics, version information (e.g., a version number) and any other suitable data.

At operation 610, the index manager (e.g., index manager 72) may issue a query user:analytics (also referred to herein as author:analytics) to a text index (e.g., text index 93). At operation 615, the index manager (e.g., index manager 72) may retrieve the metadata stored in the text index (e.g., text index 93) associated with user:analytics. At operation 620, the index manager (e.g., index manager 72) may check the differences between the metadata retrieved from the master storage (e.g., master storage 92) and the text index (e.g., text index 93) and for each UUID and version combination in master storage (MS) but which is not in text index, the index manager (e.g., index manager 72) may get the corresponding UUID and version information (e.g., Get(UUID:version)) from the master storage (e.g., master storage 92). The corresponding UUID and version information may be associated with user analytics. At operation 625, the index manager (e.g., index manager 72) may retrieve the asset entry for UUID:version from the master storage. At operation 630, the index manager (e.g., index manager 72) may perform an index operation and may write the UUID:version and the missing metadata associated with user analytics to the text index (e.g., text index 93). In this regard, the data associated with user analytics in the master storage may be written to the text index to resolve any data conflicts as it pertains to user analytics.

As described above, in an alternative example embodiment, the index manager 72 may design data for the master storage 92 by identifying each asset entry by a unique key in the master storage 92. The unique key may be comprised of a UUID and version number. The value of the key may be the content of the asset entry. As such, in this example embodiment each key may be associated at least with a version number.

Additionally, in this alternative example embodiment, the index manager 72 may identify each user or service by a unique key in master storage 92 such as, for example, by {service}:‘version’ Key. In this regard, for example, a user or service analytics may have a corresponding analytics:version in the master storage 92. The value of the key may be defined by the index manager 72 to have a listing of the asset entries associated with the service or user and some metadata (e.g., a UUID(s), version information (e.g., a version number), timestamp information, (e.g., a creation date, a creation time), an author or originator (e.g., a user) of a document(s), etc.).

Furthermore, in this example embodiment, the index manager 72 may maintain a special key (which may be designated, for example, as a CATALOGKey or any other suitable designation) whose value may be a listing of all the users or services that published (e.g., wrote) corresponding data (e.g., a data model (e.g., a document)) in the master storage 92.

In this alternative example embodiment, the index manager 72 may perform data publishing operations in the following manner. First, the index manager 72 may perform a Get operation to retrieve version information from a unique key (e.g., service:version) in the master storage 92 in response to receipt of a message to publish a UUID. Next, the index manager 72 may perform a Put operation for a unique key such as, for example, {service}:‘version’ to update version information for the unique key (e.g., {service}:‘version’, (UUID, v+1)).

Subsequently, the index manager 72 may perform a Put operation to save content (e.g., payload data (e.g., metadata)) associated with the unique key (e.g., (UUID: v+1, payload)) to the master storage 92. Thereafter, the index manager 72 may invoke an indexing process to write the unique key, the updated version number and corresponding payload data (e.g., UUID: v+1, payload), stored in the master storage 92, to the text index 93.

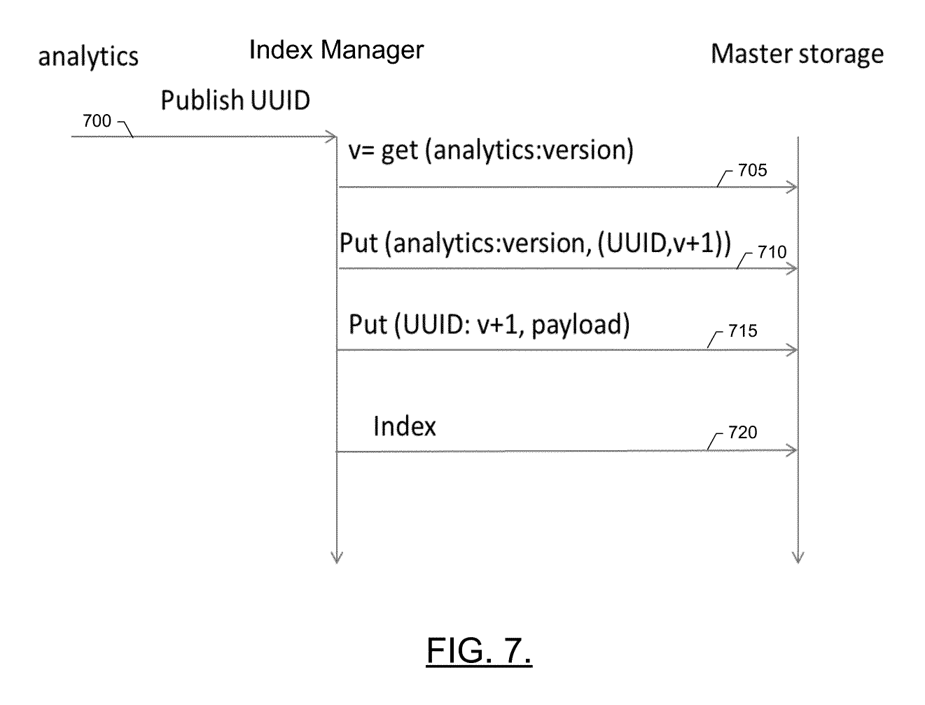

Referring now to FIG. 7, an example method of a publishing access plan is provided according to an alternative example embodiment. The publishing access plan (e.g., a writing access plan) may be for a service or user such as, for example, a user named analytics. At operation 700, the index manager 72 may receive an indication that a user analytics is publishing (e.g., writing) UUID. The indication may be received by the index manager 72 from an interface (e.g., API 97) in response to input by the user to publish the UUID. At operation 705, the index manager 72 may retrieve, from the master storage 92, the version information for the UUID being published (e.g., get (analytics:version)). In the example embodiment of FIG. 7, the key where the version information is stored, in the master storage 92, is analytics:version. At operation 710, the index manager 72 may update the version, v, for the UUID (e.g., analytics:version, (UUID, v+1)).

At operation 715, the index manager 72 may store payload data in the key UUID: v+1 to obtain UUID: v+1, payload. The payload may include metadata and any other suitable data. The metadata may include, but is not limited to, version information (e.g., a version number), timestamp information (e.g., a creation date, a creation time), an author (e.g., a user) or originator of data (e.g., a data model (e.g., a document(s))), etc. At operation 720, the index manager 72 may perform an indexing process to write the key UUID: v+1 and associated metadata stored in the master storage 92, to the text index 93.

In this example embodiment, the index manager 72 may allow for gaps in a version number. For example, as a result of a partial failure the index manager 72 may enable the master storage 92 to include one or more asset entries for version n, n+1, n+3.

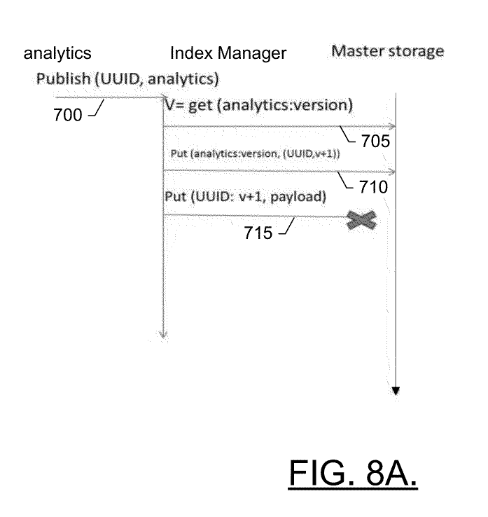

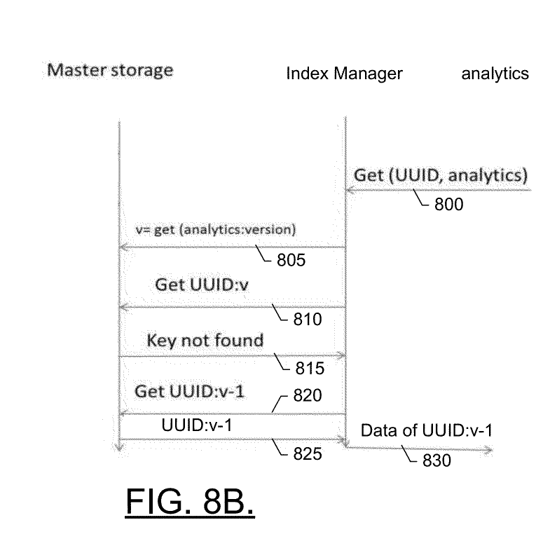

Referring now to FIG. 8A, a diagram illustrating a partial failure for a publish operation according to an alternative example embodiment is provided. FIG. 8A shows a detection of a failure in an instance in which a service or user analytics publishes (e.g., writes) a UUID. In the example embodiment of FIG. 8A, the failure occurs after operation 710 in which the index manager 72 performed a Put operation to update key analytics:version with updated version information. The example of FIG. 8A shows that while the version was incremented successfully (e.g., v+1), the actual asset entry was not stored in the master storage 92. As such, the index manager 72 may generate an indication (e.g., a visible indication) of an error and may provide the indication of the error to a display (e.g., display 85) for viewing by the user (e.g., user analytics). In one example embodiment, this failure may be reconciled on a next publish operation. For example, during another publish operation, the index manager 72 executes operation 710 to increment the version information associated with the key analytics:version and may proceed with operation 715 to update the key with the value.

Referring now to FIG. 8B, a diagram illustrating reconciliation of the failure in FIG. 8A is provided according to an alternative example embodiment. In the example embodiment of FIG. 8B, the index manager 72 may receive an indication of a Get request before a second publish operation takes place. To reconcile the failure, the index manager 72 may retrieve a previous version of the UUID, as described more fully below.

At operation 800, the index manager 72 may receive an indication of a Get request (e.g., Get (UUID, analytics)). The Get request may be generated on behalf of user analytics. The Get request may be provided to the index manager 72 in response to input by user analytics in which the input may be detected by an interface (e.g., API 97). At operation 805, in response to receipt of the indication of the Get request, the index manager 72 may perform a Get operation to retrieve version information from analytics:version. At operation 810, the index manager 72 may perform a Get operation and may request the version information of a UUID (e.g., UUID:v) corresponding to key analytics:version from the master storage 92. At operation 815, the index manager 72 may receive an indication (e.g., Key not found) that the current version information of the UUID is not found in the master storage 92.

At operation 820, the index manager 72 may perform a Get operation requesting the immediate prior version of the UUID (e.g., Get UUID: v−1) in response to receipt of the indication that the current version information of the UUID is not found in the master storage 92. At operation 825, the index manager 72 may receive the prior version of the UUID (e.g., UUID: v−1) from the master storage 92. At operation 830, the index manager 72 may provide the data (e.g., a document, etc.,) associated with the prior version of the UUID (e.g., UUID: v−1) to a display (e.g., display 85) to enable the user analytics to view the data.

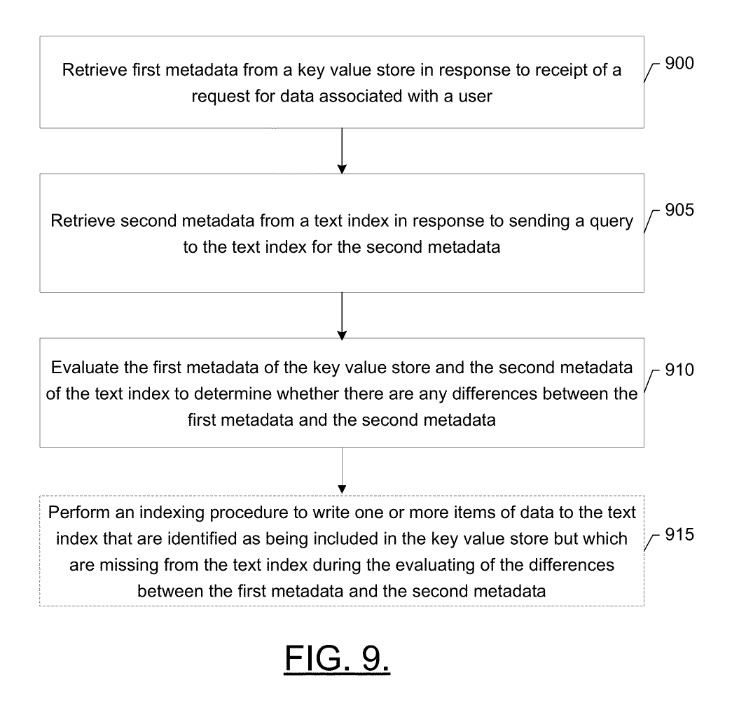

Referring now to FIG. 9, a flowchart of an example method for reconciling data inconsistencies between a master storage and a text index is provided according to an example embodiment. At operation 900, an apparatus (e.g., apparatus 50) may retrieve first metadata from a key value store (e.g., key value store 92) in response to receipt of a request for data associated with a user (e.g., user analytics). At operation 905, an apparatus (e.g., apparatus 50) may retrieve second metadata from a text index (e.g., text index 93) in response to sending a query to the text index for the second metadata. The second metadata may correspond to the first metadata of the key value store.

At operation 910, an apparatus (e.g., apparatus 50) may evaluate the first metadata of the key value store and the second metadata of the text index to determine whether there are any differences between the first metadata and the second metadata. Optionally, at operation 915, an apparatus (e.g., apparatus 50) may perform an indexing procedure to write one or more items of data to the text index that are identified as being included in the key value store but which are missing from the text index during the evaluating of the differences between the first metadata and the second metadata.

It should be pointed out that FIGS. 4, 5A, 5B, 5C, 5D, 6, 7, 8A, 8B and 9 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, key value store 92, text index 93) and executed by a processor (e.g., processor 70). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 4, 5A, 5B, 5C, 5D, 6, 7, 8A, 8B and 9 above may comprise a processor (e.g., the processor 70) configured to perform some or each of the operations (400-440), (400-420), (400-425), (400-430), (400-435), (600-630), (700-720), (700-715), (800-830) and (900-915) described above. The processor may, for example, be configured to perform the operations (400-440), (400-420), (400-425), (400-430), (400-435), (600-630), (700-720), (700-715), (800-830) and (900-915) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (400-440), (400-420), (400-425), (400-430), (400-435), (600-630), (700-720), (700-715), (800-830) and (900-915) may comprise, for example, the processor 70 (e.g., as means for performing any of the operations described above), the index manager 72 and/or a device or circuitry for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
retrieving first metadata from a key value store in response to receipt of a request for data associated with a user;
retrieving second metadata, corresponding to the first metadata of the key value store, from a text index in response to querying the text index for the second metadata; and
evaluating, via a processor, the first metadata of the key value store and the second metadata of the text index to determine whether there are any differences between the first metadata and the second metadata.

2. The method of claim 1, further comprising:
performing an indexing procedure to enable writing of one or more items of data to the text index that are identified as being included in the key value store but which are missing from the text index during the evaluating of the differences between the first metadata and the second metadata.

3. The method of claim 2, wherein prior to performing the indexing procedure, the method further comprises:
determining that the items of data comprises information associated with one or more unique keys and items of version information corresponding to the unique keys that are included in the key value store but which are not included in the text index during the evaluating of the differences.

4. The method of claim 1, wherein prior to retrieving the first metadata, the method further comprises:
designating the key value store as the authoritative data source for resolving data conflicts with the text index.

5. The method claim 1, wherein the first metadata and the second metadata are associated with a same user or service that is an author or originator of corresponding content in the key value store.

6. The method of claim 1, wherein prior to retrieving first metadata, the method further comprises:
associating the first metadata with a unique key that uniquely identifies a user or service and information indicating a version of the unique key.

7. The method of claim 1, wherein the first metadata comprises at least one of a key of the requested data stored in the key value store, version information, timestamp information or an indication of an author or originator of the requested data.

8. The method of claim 1, further comprising:
detecting a failure during a process of writing content for storage in the key value store;
recovering a previous version of a unique key associated with the written content in response to the detected failure; and
continuing the writing of the content to the key value store based in part on information associated with the previous version of the unique key.

9. The method of claim 2, wherein prior to performing the indexing procedure, the method further comprises:
detecting a failure in storing at least one unique key to the key value store;
retrieving the first metadata from a designated user key or service key stored in the key value store to identify a current version of the unique key, that was not properly stored in the key value store, in response to the detected failure; and
enabling storage, in the key value store, of the unique key with information indicating the current version and payload data comprising the first metadata in order to resolve the failure.

10. An apparatus comprising:
at least one processor; and
at least one memory including computer program code configured to, with the at least one processor, cause the apparatus to perform at least the following:
retrieve first metadata from a key value store in response to receipt of a request for data associated with a user;
retrieve second metadata, corresponding to the first metadata of the key value store, from a text index in response to querying the text index for the second metadata; and
evaluate the first metadata of the key value store and the second metadata of the text index to determine whether there are any differences between the first metadata and the second metadata.

11. The apparatus of claim 10, wherein the memory and computer program code are configured to, with the processor, cause the apparatus to:
perform an indexing procedure to enable writing of one or more items of data to the text index that are identified as being included in the key value store but which are missing from the text index during the evaluating of the differences between the first metadata and the second metadata.

12. The apparatus of claim 11, wherein prior to perform the indexing procedure, the memory and computer program code are configured to, with the processor, cause the apparatus to:
determine that the items of data comprises information associated with one or more unique keys and items of version information corresponding to the unique keys that are included in the key value store but which are not included in the text index during the evaluating of the differences.

13. The apparatus of claim 10, wherein prior to retrieve the first metadata, the memory and computer program code are configured to, with the processor, cause the apparatus to:
designate the key value store as the authoritative data source for resolving data conflicts with the text index.

14. The apparatus claim 10, wherein the first metadata and the second metadata are associated with a same user or service that is an author or originator of corresponding content in the key value store.

15. The apparatus of claim 10, wherein prior to retrieve first metadata, the memory and computer program code are configured to, with the processor, cause the apparatus to:
associate the first metadata with a unique key that uniquely identifies a user or service and information indicating a version of the unique key.

16. The apparatus of claim 10, wherein the first metadata comprises at least one of a key of the requested data stored in the key value store, version information, timestamp information or an indication of an author or originator of the requested data.

17. The apparatus of claim 10, wherein the memory and computer program code are configured to, with the processor, cause the apparatus to:
detect a failure during a process of writing content for storage in the key value store;
recover a previous version of a unique key associated with the written content in response to the detected failure; and
continue the writing of the content to the key value store based in part on information associated with the previous version of the unique key.

18. The apparatus of claim 11, wherein prior to perform the indexing procedure, the memory and computer program code are configured to, with the processor, cause the apparatus to:
detect a failure in storing at least one unique key to the key value store;
retrieve the first metadata from a designated user key or service key stored in the key value store to identify a current version of the unique key, that was not properly stored in the key value store, in response to the detected failure; and
enable storage, in the key value store, of the unique key with information indicating the current version and payload data comprising the first metadata in order to resolve the failure.

19. A computer program product comprising at least one non-transitory computer-readable storage medium having computer-readable program code portions stored therein, the computer-readable program code portions comprising:
program code instructions configured to retrieve first metadata from a key value store in response to receipt of a request for data associated with a user;
program code instructions configured to retrieve second metadata, corresponding to the first metadata of the key value store, from a text index in response to querying the text index for the second metadata; and
program code instructions configured to evaluate the first metadata of the key value store and the second metadata of the text index to determine whether there are any differences between the first metadata and the second metadata.

20. The computer program product of claim 19, further comprising:
program code instructions configured to perform an indexing procedure to enable writing one or more items of data to the text index that are identified as being included in the key value store but which are missing from the text index during the evaluating of the differences between the first metadata and the second metadata.
